(19) United States
(12) Patent Application Publication
(10) Pub. No.: US 2024/0178958 A1
(43) Pub. Date: May 30, 2024

(54) APPARATUS, SYSTEM, AND METHOD OF WIRELESS COMMUNICATION OF TIME INFORMATION CORRESPONDING TO A PLURALITY OF TIME DOMAINS

(71) Applicants: Dave Cavalcanti, Portland, OR (US); Nico Georghiou, Hadera (IL); Elad Oren, Tel Aviv (IL); Avraham Stern, Givat Zeev (IL); Susruth Sudhakaran, Portland, OR (US); Ganesh Venkatesan, Hillsboro, OR (US)

(72) Inventors: Dave Cavalcanti, Portland, OR (US); Nico Georghiou, Hadera (IL); Elad Oren, Tel Aviv (IL); Avraham Stern, Givat Zeev (IL); Susruth Sudhakaran, Portland, OR (US); Ganesh Venkatesan, Hillsboro, OR (US)

(21) Appl. No.: 18/399,426

(22) Filed: Dec. 28, 2023

(51) Int. Cl. H04L 5/00; H04W 72/30

(52) U.S. Cl. CPC H04L 5/0048; H04W 72/30

(57) ABSTRACT

For example, an Access Point (AP) may be configured to set a plurality of follow-up-information fields corresponding to a plurality of time domains. For example, the plurality of follow-up-information fields may include a first follow-up-information field and a second follow-up-information field. For example, the first follow-up-information field may include first time information corresponding to a first time domain, and the second follow-up-information field may include second time information corresponding to a second time domain. For example, the AP may be configured to transmit a time-measurement frame to a non-AP station (STA). For example, the time-measurement frame may be configured to include the plurality of follow-up-information fields.

### BACKGROUND

Some devices and/or networks may be configured to utilize protocols, which may be configured to ensure that the synchronization requirements are met for time-sensitive applications, such as audio, video, and time-sensitive control, across networks.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of deployment of a device of a wireless communication system utilizing a plurality of time domains, which may be implemented in accordance with some demonstrative aspects.

FIG. 3 is a schematic illustration of a Timing Measurement (TM) protocol supporting multiple time domains, in accordance with some demonstrative aspects.

FIG. 4 is a schematic illustration of a Fine Timing Measurement (FTM) protocol supporting multiple time domains, in accordance with some demonstrative aspects.

FIG. 5 is a schematic illustration of a time-measurement frame format, in accordance with some demonstrative aspects.

FIG. 6 is a schematic illustration of a header field format, which may be implemented in accordance with some demonstrative aspects.

FIG. 7 is a schematic illustration of a compressed follow-up information element format, in accordance with some demonstrative aspects.

FIG. 8 is a schematic illustration of a time-measurement frame format, in accordance with some demonstrative aspects.

FIG. 9 is a schematic illustration of a time-measurement frame format, in accordance with some demonstrative aspects.

FIG. 10 is a schematic flow-chart illustration of a method of wireless communication of time information corresponding to a plurality of time domains, in accordance with some demonstrative aspects.

FIG. 11 is a schematic flow-chart illustration of a method of wireless communication of time information corresponding to a plurality of time domains, in accordance with some demonstrative aspects.

FIG. 12 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IOT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology—Telecommunications and Information Exchange between Systems Local and Metropolitan Area Networks-Specific Requirements; Part 11: Wireless LAN Medium Access Control (MAC) and Physical Layer (PHY) Specifications, December, 2020); and/or IEEE 802.11be (IEEE P802.11be/D5.0 Draft Standard for Information technology—Telecommunications and information exchange between systems Local and metropolitan area networks—Specific requirements; Part 11: Wireless LAN Medium Access Control (MAC) and Physical Layer (PHY) Specifications; Amendment 8: Enhancements for extremely high throughput (EHT), November 2023)) and/or future versions and/or derivatives thereof, devices and/or networks operating in accordance with existing IEEE 802.1AS standards (including IEEE 802.1AS-2020 (IEEE 802.1AS—2020, IEEE Standard for Local and Metropolitan Area Networks—Timing and Synchronization for Time—Sensitive Applications, January 2020)) and/or future versions and/or derivatives thereof, devices and/or networks operating in accordance with existing IEEE 1588 standards (including IEEE 1588-2019 (IEEE 1588-2019, IEEE Standard for a Precision Clock Synchronization Protocol for Networked Measurement and Control Systems, November 2019)) and/or future versions and/or derivatives thereof, devices and/or networks operating in accordance with existing cellular specifications and/or protocols, and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™. Ultra-Wideband (UWB), 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated or group), and/or memory (shared. Dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a WiFi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a 2.4 GHz frequency band, a 5 GHz frequency band, a 6 GHz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 Ghz and 300 GHz, for example, a frequency band above 45 GHz, e.g., a 60 GHz frequency band, and/or any other mmWave frequency band. Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (S1G) band, a WLAN frequency band, a WPAN frequency band, and the like.

Some demonstrative aspects may be implemented by an mmWave STA (mSTA), which may include for example, a STA having a radio transmitter, which is capable of operating on a channel that is within the mmWave frequency band. In one example, mmWave communications may involve one or more directional links to communicate at a rate of multiple gigabits per second, for example, at least 1 Gigabit per second, e.g., at least 7 Gigabit per second, at least 30 Gigabit per second, or any other rate.

In some demonstrative aspects, the mmWave STA may include a Directional Multi-Gigabit (DMG) STA, which may be configured to communicate over a DMG frequency band. For example, the DMG band may include a frequency band wherein the channel starting frequency is above 45 GHZ.

In some demonstrative aspects, the mmWave STA may include an Enhanced DMG (EDMG) STA, which may be configured to implement one or more mechanisms, which may be configured to enable Single User (SU) and/or Multi-User (MU) communication of Downlink (DL) and/or Uplink frames (UL) using a MIMO scheme. For example, the EDMG STA may be configured to implement one or more channel bonding mechanisms, which may, for example, support communication over a channel bandwidth (BW) (also referred to as a “wide channel”, an “EDMG channel”, or a “bonded channel”) including two or more channels, e.g., two or more 2.16 GHz channels. For example, the channel bonding mechanisms may include, for example, a mechanism and/or an operation whereby two or more channels, e.g., 2.16 GHz channels, can be combined, e.g., for a higher bandwidth of packet transmission, for example, to enable achieving higher data rates, e.g., when compared to transmissions over a single channel. Some demonstrative aspects are described herein with respect to communication over a channel BW including two or more 2.16 GHz channels, however other aspects may be implemented with respect to communications over a channel bandwidth, e.g., a “wide” channel, including or formed by any other number of two or more channels, for example, an aggregated channel including an aggregation of two or more channels. For example, the EDMG STA may be configured to implement one or more channel bonding mechanisms, which may, for example, support an increased channel bandwidth, for example, a channel BW of 4.32 GHZ, a channel BW of 6.48 GHz, a channel BW of 8.64 GHZ, and/or any other additional or alternative channel BW. The EDMG STA may perform other additional or alternative functionality.

In other aspects, the mmWave STA may include any other type of STA and/or may perform other additional or alternative functionality. Other aspects may be implemented by any other apparatus, device and/or station.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

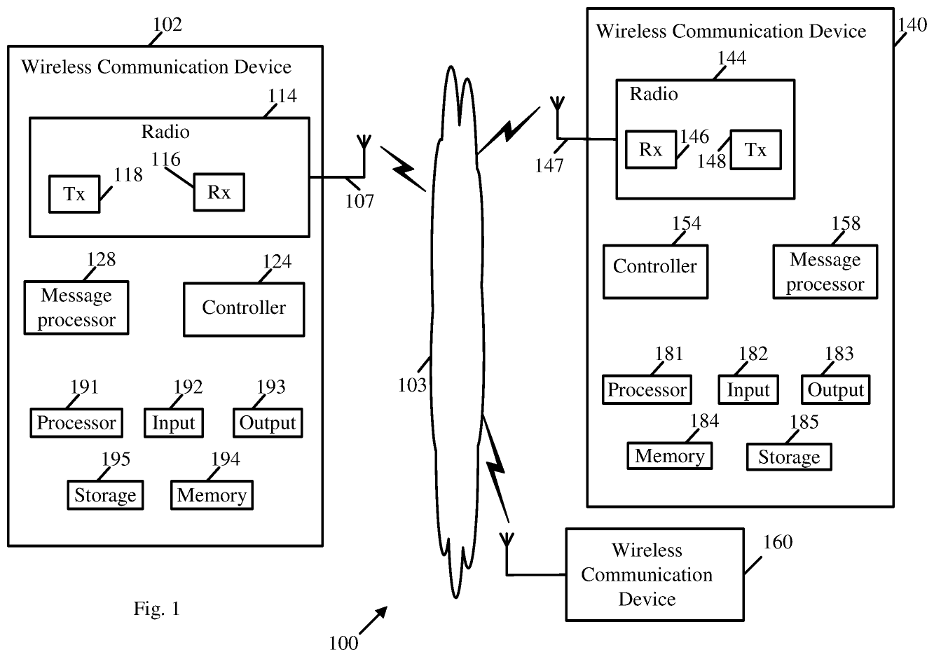

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, a wireless communication device 160, and/or one more other devices.

In some demonstrative aspects, devices 102, 140, and/or 160 may include a mobile device or a non-mobile, e.g., a static, device.

For example, devices 102, 140, and/or 160 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IOT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player or the like.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an Operating System (OS) of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a disk drive, a solid-state drive (SSD), and/or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102, 140, and/or 160 may be capable of communicating content, data, information and/or signals via a wireless medium (WM) 103. In some demonstrative aspects, wireless medium 103 may include, for example, a radio channel, an RF channel, a WiFi channel, a cellular channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10 Ghz wireless communication frequency band, for example, a 2.4 GHz wireless communication frequency band, one or more channels in a 5 GHz wireless communication frequency band, and/or one or more channels in a 6 GHz wireless communication frequency band. In another example, WM 103 may additionally or alternatively include one or more channels in an mmWave wireless communication frequency band. In other aspects, WM 103 may include any other type of channel over any other frequency band.

In some demonstrative aspects, device 102, device 140, and/or device 160 may include one or more radios including circuitry and/or logic to perform wireless communication between devices 102, 140, 160, and/or one or more other wireless communication devices. For example, device 102 may include one or more radios 114, and/or device 140 may include one or more radios 144.

In some demonstrative aspects, radios 114 and/or radios 144 may include one or more wireless receivers (Rx) including circuitry and/or logic to receive wireless communication signals, RF signals, frames, blocks, transmission streams, packets, messages, data items, and/or data. For example, a radio 114 may include at least one receiver 116, and/or a radio 144 may include at least one receiver 146.

In some demonstrative aspects, radios 114 and/or 144 may include one or more wireless transmitters (Tx) including circuitry and/or logic to transmit wireless communication signals, RF signals, frames, blocks, transmission streams, packets, messages, data items, and/or data. For example, a radio 114 may include at least one transmitter 118, and/or a radio 144 may include at least one transmitter 148.

In some demonstrative aspects, radios 114 and/or 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radios 114 and/or 144 may include or may be implemented as part of a wireless Network Interface Card (NIC), and the like.

In some demonstrative aspects, radios 114 and/or 144 may be configured to communicate over a 2.4 GHz band, a 5 GHz band, a 6 GHz band, and/or any other band, for example, a directional band, e.g., an mm Wave band, a 5G band, an SIG band, and/or any other band.

In some demonstrative aspects, radios 114 and/or 144 may include, or may be associated with one or more antennas.

In some demonstrative aspects, device 102 may include one or more antennas 107, and/or device 140 may include on or more antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140, 160 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140, 160 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of radio 114, and/or at least part of the functionality of controller 154 may be implemented as part of one or more elements of radio 144.

In other aspects, the functionality of controller 124 may be implemented as part of any other element of device 102, and/or the functionality of controller 154 may be implemented as part of any other element of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or more messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of radio 114, and/or at least part of the functionality of message processor 158 may be implemented as part of radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of one or more radios 114. For example, the chip or SoC may include one or more elements of controller 124, one or more elements of message processor 128, and/or one or more elements of one or more radios 114. In one example, controller 124, message processor 128, and one or more radios 114 may be implemented as part of the chip or SoC.

In other aspects, controller 124, message processor 128 and/or one or more radios 114 may be implemented by one or more additional or alternative elements of device 102.

In some demonstrative aspects, at least part of the functionality of controller 154 and/or message processor 158 may be implemented by an integrated circuit, for example, a chip, e.g., a SoC. In one example, the chip or SoC may be configured to perform one or more functionalities of one or more radios 144. For example, the chip or SoC may include one or more elements of controller 154, one or more elements of message processor 158, and/or one or more elements of one or more radios 144. In one example, controller 154, message processor 158, and one or more radios 144 may be implemented as part of the chip or SoC.

In other aspects, controller 154, message processor 158 and/or one or more radios 144 may be implemented by one or more additional or alternative elements of device 140.

In some demonstrative aspects, device 102, device 140, and/or device 160 may include, operate as, perform the role of, and/or perform one or more functionalities of, one or more STAs. For example, device 102 may include at least one STA, device 140 may include at least one STA, and/or device 160 may include at least one STA.

In some demonstrative aspects, device 102, device 140, and/or device 160 may include, operate as, perform the role of, and/or perform one or more functionalities of, one or more Extremely High Throughput (EHT) STAs. For example, device 102 may include, operate as, perform the role of, and/or perform one or more functionalities of, one or more EHT STAs, and/or device 140 may include, operate as, perform the role of, and/or perform one or more functionalities of, one or more EHT STAs.

In some demonstrative aspects, for example, device 102, device 140, and/or device 160 may be configured to perform one or more operations, and/or functionalities of a WiFi 8 STA.

In other aspects, for example, devices 102, 140 and/or 160 may be configured to perform one or more operations, and/or functionalities of an Ultra High Reliability (UHR) STA.

In other aspects, for example, devices 102, 140, and/or 160 may be configured to perform one or more operations, and/or functionalities of any other additional or alternative type of STA.

In other aspects, device 102, device 140, and/or device 160 may include, operate as, perform the role of, and/or perform one or more functionalities of, any other wireless device and/or station, e.g., a WLAN STA, a WiFi STA, and the like.

In some demonstrative aspects, device 102, device 140, and/or device 160 may be configured operate as, perform the role of, and/or perform one or more functionalities of, an Access Point (AP), e.g., a High Throughput (HT) AP STA, a High Efficiency (HE) AP STA, an EHT AP STA and/or a UHR AP STA.

In some demonstrative aspects, device 102, device 140, and/or device 160 may be configured to operate as, perform the role of, and/or perform one or more functionalities of, a non-AP STA, e.g., an HT non-AP STA, an HE non-AP STA, an EHT non-AP STA and/or a UHR non-AP STA.

In other aspects, device 102, device 140, and/or device 160 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains one station (STA) and provides access to the distribution services, via the wireless medium (WM) for associated STAs. An AP may include a STA and a distribution system access function (DSAF). The AP may perform any other additional or alternative functionality.

In some demonstrative aspects devices 102, 140, and/or 160 may be configured to communicate in an HT network, an HE network, an EHT network, a UHR network, and/or any other network.

In some demonstrative aspects, devices 102, 140 and/or 160 may be configured to operate in accordance with one or more Specifications, for example, including one or more IEEE 802.11 Specifications, and/or any other specification and/or protocol.

In some demonstrative aspects, device 102 may include, operate as, perform a role of, and/or perform the functionality of, an AP STA.

In some demonstrative aspects, device 140, and/or device 160 may include, operate as, perform a role of, and/or perform the functionality of, one or more non-AP STAs. For example, device 140 may include, operate as, perform a role of, and/or perform the functionality of, at least one non-AP STA, and/or device 160 may include, operate as, perform a role of, and/or perform the functionality of, at least one non-AP STA.

In some demonstrative aspects, device 102, device 140, and/or device 160 may include, operate as, perform a role of, and/or perform the functionality of, a Multi-Link Device (MLD). For example, device 102 may include, operate as, perform a role of, and/or perform the functionality of, at least one MLD, device 140 may include, operate as, perform a role of, and/or perform the functionality of, at least one MLD, and/or device 160 may include, operate as, perform a role of, and/or perform the functionality of, at least one MLD, e.g., as described below.

For example, an MLD may include a device that is a logical entity that is capable of supporting more than one affiliated station (STA) and can operate using one or more affiliated STAs. For example, the MLD may present one Medium Access Control (MAC) data service and a single MAC Service Access Point (SAP) to the Logical Link Control (LLC) sublayer. The MLD may perform any other additional or alternative functionality.

In some demonstrative aspects, for example, an infrastructure framework may include a multi-link AP logical entity, which includes APs, e.g., on one side, and a multi-link non-AP logical entity, which includes non-APs, e.g., on the other side.

In some demonstrative aspects, device 102, device 140, and/or device 160 may be configured to operate as, perform the role of, and/or perform one or more functionalities of, an AP MLD.

In some demonstrative aspects, device 102, device 140, and/or device 160 may be configured to operate as, perform the role of, and/or perform one or more functionalities of, a non-AP MLD.

In other aspects, device 102, device 140, and/or device 160 may operate as, perform the role of, and/or perform one or more functionalities of, any other additional or alternative device and/or station.

For example, an AP MLD may include an MLD, where each STA affiliated with the MLD is an AP. In one example, the AP MLD may include a multi-link logical entity, where each STA within the multi-link logical entity is an EHT AP. The AP MLD may perform any other additional or alternative functionality.

For example, a non-AP MLD may include an MLD, where each STA affiliated with the MLD is a non-AP STA. In one example, the non-AP MLD may include a multi-link logical entity, where each STA within the multi-link logical entity is a non-AP EHT STA. The non-AP MLD may perform any other additional or alternative functionality.

In some demonstrative aspects, device 102, device 140, and/or device 160 may be configured to implement one or more operations and/or functionalities of a timing mechanism, which may be configured to support multiple time domains, for example, in accordance with an IEEE 802.1AS Standard and/or an IEEE 1588 Standard, e.g., as described below.

In some demonstrative aspects, the timing mechanism may be configured to support wireless communication of time information corresponding to a plurality of time domains, e.g., as described below.

In some demonstrative aspects, the timing mechanism may be configured to support wireless communication of time information corresponding to a plurality of time domains, for example, based on an extension of a time measurement mechanism, e.g., in accordance with a IEEE 802.1AS Standard, e.g., as described below.

For example, a time measurement mechanism, e.g., in accordance with an IEEE 802.1AS Standard, may be limited to one, e.g., only one, Fine Timing Measurement (FTM) session to be negotiated between an FTM initiator and an FTM responder. For example, in order to support more than one time domain, e.g., n time domains, the number of FTMs per burst, e.g., as negotiated during an FTM session setup, may be, e.g., should be, n times the number of FTMs used for each time domain.

For example, negotiating the number of FTMs per burst to be a multiple of the number of supported time domains, e.g., n time domains, may render the utilization of the wireless media inefficient, for example, since too many FTM frames are to be transmitted.

For example, negotiating the number of FTMs per burst to be a multiple of the number of supported time domains, e.g., n time domains, may degrade time synchronization performance, for example, as a result of not being able to transmit all the required FTM frames within the negotiated burst period.

For example, negotiating a number of FTMs per burst to be a multiple of the number of supported time domains, e.g., n time domains, may place an undue burden on the FTM responder, which may result in the FTM responder being unable to perform networking functions, which may be its primary responsibility.

For example, negotiating a number of FTMs per burst to be a multiple of the number of supported time domains, e.g., n time domains, may result in the number of FTMs per burst increase with the value of n, resulting in increased burst periods.

For example, a burst period may increase, for example, based on how frequently the FTM responder may transmit FTM frames, and/or based on the value of n. For example, the increased number of FTMs per burst may result in inefficient usage of the wireless medium, since each FTM transmission requires gaining access to the wireless medium.

In some demonstrative aspects, device 102, device 140, and/or device 160 may be configured to implement one or more operations and/or functionalities of a time measurement mechanism, which may be configured to support multiple time domains, e.g., as described below.

In some demonstrative aspects, device 102, device 140, and/or device 160 may be configured to implement one or more operations and/or functionalities of a time measurement mechanism, which may be configured to provide a technical solution to support multiple time domains, for example, while maintaining a number of FTMs per burst, e.g., independent of a number of time domains, e.g., as described below.

In some demonstrative aspects, the time measurement mechanism may be configured to provide a technical solution to support multiple time domains, for example, while maintaining a number of FTMs per burst, for example, substantially the same as the number of FTMs per burst when only one time domain is supported, e.g., as described below.

In some demonstrative aspects, the time measurement mechanism may be configured to provide a technical solution to maintain the number of FTMs per Burst constant, for example, independent of the number of supported time domains, e.g., as described below.

In some demonstrative aspects, device 102, device 140, and/or device 160 may be configured to implement one or more operations and/or functionalities of a time measurement mechanism, which may be configured to provide a technical solution to support Time-Sensitive Networking (TSN) applications, which may require support for multiple time domains, e.g., as described below.

In some demonstrative aspects, the time measurement mechanism may be configured to provide a technical solution to support a Wireless TSN implementation, for example, in Automotive domains, Industrial domains, Aerospace domains and/or any other additional or alternative domains, which may define that support for multiple time domains is mandatory.

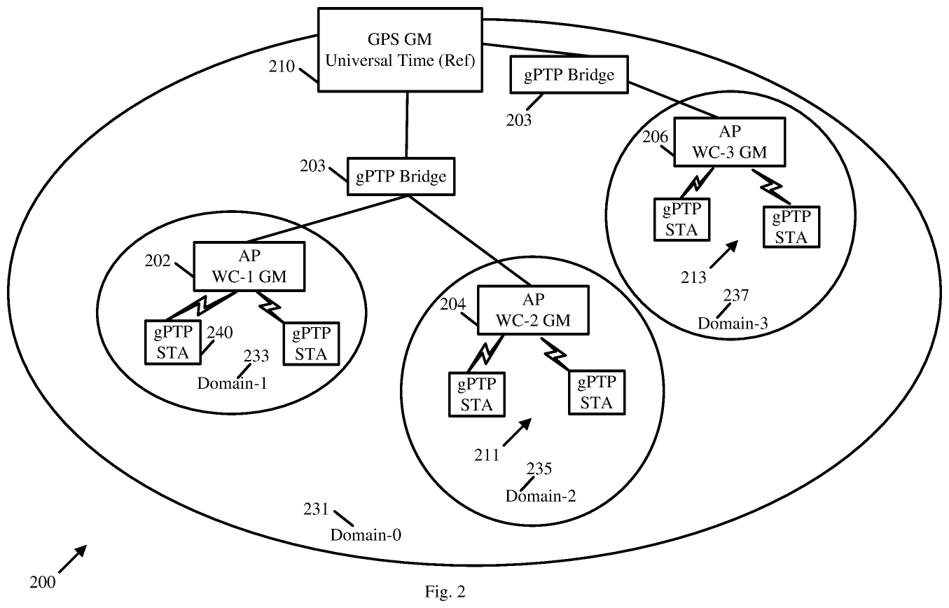

Reference is made to FIG. 2, which schematically illustrates a deployment of devices of a wireless communication system 200 utilizing multiple time domains, which may be implemented in accordance with some demonstrative aspects.

For example, as shown in FIG. 2, wireless communication system 200 may include multiple time domains, for example, a time domain 231 (Domain-0), a time domain 233 (Domain-1), a time domain 235 (Domain-2), and/or a time domain 237 (Domain-3).

For example, as shown in FIG. 2, time domain 231 may be managed by a GPS Grandmaster (GM) 210 configured to provide universal, e.g., global, time reference.

For example, as shown in FIG. 2, GPS GM 210 may be associated with one or more APs via one or more Generalized Precision Time Protocol (gPTP) bridges 203.

For example, as shown in FIG. 2, GPS GM 210 may be associated with an AP 202 (AP Working Clock 1 (WC-1) GM), which may be configured to manage a Basic Service Set (BSS) with the time domain 233.

For example, as shown in FIG. 2, AP 202 may be associated with one or more gPTP STAs. For example, AP 202 may be associated with a gPTP STA 240.

In one example, AP 202 may include one or more elements of wireless communication device 102 (FIG. 1), and/or may perform one or more operations and/or functionalities of wireless communication device 102 (FIG. 1).

In one example, gPTP STA 240 may include one or more elements of wireless communication device 140 (FIG. 1), and/or may perform one or more operations and/or functionalities of wireless communication device 140 (FIG. 1).

For example, as shown in FIG. 2, GPS GM 210 may be associated with an AP 204 (AP WC-2 GM), which may be configured to manage a BSS with the time domain 235. For example, as shown in FIG. 2, AP 204 may be associated with one or more gPTP STAs 211.

For example, as shown in FIG. 2, GPS GM 210 may be associated with an AP 206 (AP WC-3 GM), which may be configured to manage a BSS with the time domain 237. For example, AP 206 may be associated with one or more gPTP STAs 213.

For example, as shown in FIG. 2, AP 202 (AP WC-1 GM), AP 204 (AP WC-2 GM) and/or AP 206 (AP WC-3 GM) may distribute time information from GPS GM 210, as well as from corresponding APs. According to this example, a Precision Time Protocol (PTP) may operate in at least two time domains for the BSSs of AP 202, AP 204, and/or AP 206.

For example, as shown in FIG. 2, in domain 233 (Domain-1), both time domain 0 and time domain 1 may be active in the AP WC-1 GM BSS of AP 202.

For example, as shown in FIG. 2, in domain 235 (Domain-2), both time domain 0 and time domain 2 may be active in the AP WC-2 GM BSS of AP 204.

For example, as shown in FIG. 2, in domain 237 (Domain-3), both time domain 0 and time domain 3 may be active in the AP WC-3 GM BSS of AP 206.

For example, time information distributed by AP 202 (AP WC-1 GM) may include time information distributed over time domain 0 and time information distributed over time domain 1.

For example, time information distributed over time domain 0 may include a universal reference clock, for example, to indicate a global time, e.g., a year, a day, a time of a day, or the like.

For example, time information distributed over time domain 1 may include a working clock, which may be used as a reference for repetitive operations.

For example, one or more operations, e.g., repetitive operations, within domain 233 (domain-1) may be governed by working clock WC-1 of AP 202. According to this example, AP 202 (AP WC-1 GM) may transmit time information corresponding to time domain 1 to the associated gPTP STAs, e.g., gPTP STA 240, for example, using FTM frames.

For example, AP 202 (AP WC-1 GM) may operate as a Grandmaster for a corresponding Wi-Fi BSS. For example, AP 202 (AP WC-1 GM) may relay time information corresponding to time domain 0 to the associated gPTP STAs using FTM frames.

Referring back to FIG. 1, in some demonstrative aspects, device 102, device 140, and/or device 160 may be configured to implement one or more operations and/or functionalities of a time measurement mechanism, which may be configured to relay time information between a time transmitter and a time receiver, for example, by using time measurement frames, e.g., as described below.

In some demonstrative aspects, the time measurement frames may be transmitted during a time measurement session, which may be, for example, negotiated between the time transmitter and the time receiver, e.g., as described below.

In some demonstrative aspects, the time measurement mechanism may include a timing measurement mechanism, which may be configured to relay time information between a time transmitter, e.g., a TM responder, and a time receiver, e.g., a TM initiator, for example by using timing measurement frames, which may be transmitted as dictated by a TM session negotiated between the TM initiator and the TM responder, e.g., as described below.

In some demonstrative aspects, the time measurement mechanism may include a fine timing measurement mechanism, which may be configured to relay time information between a time transmitter, e.g., an FTM responder, and a time receiver, e.g., an FTM initiator, for example by using fine timing measurement frames, which may be transmitted as dictated by an FTM session negotiated between the FTM initiator and the FTM responder, e.g., as described below.

In some demonstrative aspects, device 102, device 140, and/or device 160 may be configured to implement one or more operations and/or functionalities of a time measurement mechanism, which may be configured to support wireless communication of time information corresponding to multiple time domains, e.g., as described below.

In some demonstrative aspects, device 102, device 140, and/or device 160 may be configured to implement one or more operations and/or functionalities of a time measurement mechanism, which may be configured to support wireless communication of time information corresponding to a plurality of time domains in a same time measurement frame, e.g., as descried below.

In some demonstrative aspects, device 102, device 140, and/or device 160 may be configured to implement one or more operations and/or functionalities of a time measurement mechanism, which may be configured to support wireless communication of a plurality of follow-up-information fields corresponding to a plurality of time domains, for example, in a same time measurement frame, e.g., as descried below.

In some demonstrative aspects, controller 124 may be configured to control, trigger, cause, and/or instruct an AP implemented by device 102 to set a plurality of follow-up-information fields corresponding to a plurality of time domains, e.g., as descried below.

In some demonstrative aspects, the plurality of follow-up-information fields may be configured to include a first follow-up-information field and a second follow-up-information field, e.g., as described below.

In some demonstrative aspects, the first follow-up-information field may include first time information corresponding to a first time domain, and the second follow-up-information field may include second time information corresponding to a second time domain, e.g., as described below.

In some demonstrative aspects, controller 124 may be configured to control, trigger, cause, and/or instruct the AP implemented by device 102 to transmit a time-measurement frame, which includes the plurality of follow-up-information fields, for example, to a non-AP STA, e.g., as described below.

In some demonstrative aspects, the plurality of follow-up-information fields may include more than two follow-up-information fields, e.g., as described below.

In some demonstrative aspects, the plurality of follow-up-information fields may include at least a third follow-up-information field corresponding to at least a third time domain.

In other aspects, the plurality of follow-up-information fields may include any other number of follow-up-information fields, e.g., more than three follow-up-information fields.

In some demonstrative aspects, the time-measurement frame may include a timing-measurement frame of a timing-measurement procedure, e.g., as described below.

For example, the timing-measurement frame may be configured to provide a technical solution to support a recipient STA to measure, e.g., to accurately measure, an offset of its clock relative to a clock of a sending STA. For example, with a regular transfer of timing-measurement frames from one STA to another, the recipient STA may be able to track changes in the offset of its clock with respect to the sending STA over time, which may enable the recipient STA to detect and compensate for any drift between the clocks.

In some demonstrative aspects, the time-measurement frame may include an FTM frame of an FTM procedure, e.g., as described below.

For example, the FTM frame may be configured to provide a technical solution to support a recipient STA to measure, e.g., to accurately measure, a Round Trip Time (RTT) between the recipient STA and another STA. For example, with a regular transfer of FTM frames, the recipient STA may be able to track changes in its relative location with other STAs in the environment.

In other aspects, the time-measurement frame may include any other suitable type of frame of any other suitable time-measurement procedure.

In some demonstrative aspects, the time-measurement frame may include timestamp information corresponding to a previous time-measurement frame communicated between the AP and the non-AP STA, e.g., as described below.

In some demonstrative aspects, the time-measurement frame may include a Time of Arrival (ToA) field including a ToA timestamp in a time-base of the AP, e.g., as described below.

In some demonstrative aspects, the time-measurement frame may include a Time of Departure (ToD) field, including a ToD timestamp in the time-base of the AP, e.g., as described below.

In some demonstrative aspects, controller 154 may be configured to control, trigger, cause, and/or instruct a non-AP STA implemented by device 140 to process a time-measurement frame from an AP to identify timestamp information, and a plurality of follow-up-information fields corresponding to a plurality of time domains, e.g., as described below.

In some demonstrative aspects, the plurality of follow-up-information fields may include a first follow-up-information field including first time information corresponding to a first time domain, and a second follow-up-information field including second time information corresponding to a second time domain, e.g., as described below.

For example, the received time-measurement frame may include the time-measurement frame from the AP implemented by device 102.

In some demonstrative aspects, controller 154 may be configured to control, trigger, cause, and/or instruct the non-AP STA implemented by device 140 to synchronize to one or more of the plurality of time domains, for example, based on the timestamp information and one or more of the plurality of follow-up-information fields, e.g., as described below.

In some demonstrative aspects, the first follow-up-information field may include a header field including a first domain number field, which may be configured to identify the first time domain, e.g., as described below.

In some demonstrative aspects, the second follow-up-information field may include a header field including a second domain number field, which may be configured to identify the second time domain, e.g., as described below.

For example, controller 124 may be configured to control, trigger, cause, and/or instruct the AP implemented by device 102 to set the first domain number field in the header field of the first follow-up-information field to identify the first time domain.

For example, controller 124 may be configured to control, trigger, cause, and/or instruct the AP implemented by device 102 to set the second domain number field in the header field of the second follow-up-information field to identify the second time domain.

For example, controller 154 may be configured to control, trigger, cause, and/or instruct the non-AP STA implemented by device 140 to identify the first time domain, for example, based on the first domain number field in the header field of the first follow-up-information field.

For example, controller 154 may be configured to control, trigger, cause, and/or instruct the non-AP STA implemented by device 140 to identify the second time domain, for example, based on the second domain number field in the header field of the second follow-up-information field.

In some demonstrative aspects, the first follow-up-information field may include a first precise-origin-timestamp field and/or a first follow-up information Type, Length, Value (TLV) field, e.g., as described below.

In some demonstrative aspects, the second follow-up-information field may include a second precise-origin-timestamp field and/or a second follow-up information TLV field, e.g., as described below.

For example, controller 124 may be configured to control, trigger, cause, and/or instruct the AP implemented by device 102 to set the first time information in the first follow-up-information field, for example, by setting the first precise-origin-timestamp field and/or the first follow-up information TLV field in the first follow-up-information field.

For example, controller 124 may be configured to control, trigger, cause, and/or instruct the AP implemented by device 102 to set the second time information in the second follow-up-information field, for example, by setting the second precise-origin-timestamp field and/or the second follow-up information TLV field in the second follow-up-information field.

For example, controller 154 may be configured to control, trigger, cause, and/or instruct the non-AP STA implemented by device 140 to identify the first time information in the first follow-up-information field, for example, by processing the first precise-origin-timestamp field and/or the first follow-up information TLV field in the first follow-up-information field.

For example, controller 154 may be configured to control, trigger, cause, and/or instruct the non-AP STA implemented by device 140 to identify the second time information in the second follow-up-information field, for example, by processing the second precise-origin-timestamp field and/or the second follow-up information TLV field in the second follow-up-information field.

In some demonstrative aspects, the time-measurement frame may be configured to include a first vendor specific information element and a second vendor specific information element, e.g., as described below.

In some demonstrative aspects, the first vendor specific information element may include the first follow-up-information field, e.g., as described below.

In some demonstrative aspects, the second vendor specific information element may include the second follow-up-information field, e.g., as described below.

For example, controller 124 may be configured to control, trigger, cause, and/or instruct the AP implemented by device 102 to set the first follow-up-information field in the first vendor specific information element, and to set the second follow-up-information field in the second vendor specific information element.

For example, controller 154 may be configured to control, trigger, cause, and/or instruct the non-AP STA implemented by device 140 to identify the first follow-up-information field in the first vendor specific information element, and to identify the second follow-up-information field in the second vendor specific information element.

In some demonstrative aspects, the first vendor specific information element may have a length of 82 octets, e.g., as described below.

In some demonstrative aspects, the second vendor specific information element may have a length of 82 octets, e.g., as described below.

In other aspects, the first vendor specific information element and/or the second vendor specific information element may have any other length.

In some demonstrative aspects, the first follow-up-information field may have a length of 76 octets, e.g., as described below.

In some demonstrative aspects, the second follow-up-information field may have a length of 76 octets, e.g., as described below.

In other aspects, the first follow-up-information field and/or the second follow-up-information field may have any other length.

In some demonstrative aspects, at least one of the first vendor specific information element or the second vendor specific information element may be configured as a compressed vendor specific information element, e.g., as described below.

In some demonstrative aspects, the compressed vendor specific information element may be configured to have a length of less than 82 octets, e.g., as described below.

In some demonstrative aspects, the compressed vendor specific information element may be configured to have a length of 49 octets.

In other aspects, the compressed vendor specific information element may be configured to have any other length.

In some demonstrative aspects, the first vendor specific information element may have a length of 82 octets, and the second vendor specific information element may be configured as the compressed vendor specific information element, for example which may have a length of less than 82 octets, e.g., as described below.

In some demonstrative aspects, each of the first vendor specific information element and the second vendor specific information element may be configured as the compressed vendor specific information element, for example which may have a length of less than 82 octets, e.g., as described below.

In some demonstrative aspects, the compressed vendor specific information element may include a type field, for example, to indicate a follow-up-information field type, e.g., as described below.

In some demonstrative aspects, the compressed vendor specific information element may include a compressed follow-up-information field, e.g., as described below.

In some demonstrative aspects, the compressed vendor specific information element may include the type field set to a predefined type value to indicate a compressed follow-up-information field type, e.g., as described below.

In one example, the compressed vendor specific information element may include the type field set to a first predefined type value to indicate a compressed follow-up-information field type.

In another example, the compressed vendor specific information element may include the type field set to a second predefined type value to indicate a non-compressed follow-up-information field type.

In some demonstrative aspects, at least one of the first follow-up-information field or the second follow-up-information field may be configured as the compressed follow-up-information field, e.g., as described below.

In some demonstrative aspects, the compressed follow-up-information field may be configured to have a length of less than 76 octets.

In some demonstrative aspects, the compressed follow-up-information field may be configured to have a length of 43 octets.

In other aspects, the compressed follow-up-information field may be configured to have any other length.

In some demonstrative aspects, the compressed follow-up-information field may include a compressed header field, e.g., as described below.

In some demonstrative aspects, the compressed follow-up-information field may include the compressed header field having a length of less than 34 octets, e.g., as described below.

In some demonstrative aspects, the compressed header field may be configured to have a length of 1 octet, e.g., as described below.

In other aspects, the compressed header field may have any other length.

In some demonstrative aspects, the compressed header field may include a domain number field to identify a time domain to which the compressed follow-up-information field corresponds, e.g., as described below.

In some demonstrative aspects, the time-measurement frame may be configured to include a vendor specific information element, which may include a plurality of follow-up-information fields, e.g., as described below.

In some demonstrative aspects, the time-measurement frame may be configured to include a vendor specific information element, which may include the first follow-up-information field and the second follow-up-information field.

For example, controller 124 may be configured to control, trigger, cause, and/or instruct the AP implemented by device 102 to set the first follow-up-information field and the second follow-up-information field in the vendor specific information element.

For example, controller 154 may be configured to control, trigger, cause, and/or instruct the non-AP STA implemented by device 140 to identify the first follow-up-information field and the second follow-up-information field in the vendor specific information element.

In some demonstrative aspects, the vendor specific information element may include a type field set to a predefined value to indicate that the vendor specific information element includes follow-up information, e.g., as described below.

In some demonstrative aspects, the vendor specific information element may include a count field to indicate a count of follow-up-information fields included in the vendor specific information element, e.g., as described below.

In some demonstrative aspects, the first follow-up-information field may have a length of 76 octets, and the second follow-up-information field may have a length of 76 octets, e.g., as described below.

In some demonstrative aspects, at least one of the first follow-up-information field or the second follow-up-information field may be configured as the compressed follow-up-information field having a length of less than 76 octets, e.g., as described below.

In some demonstrative aspects, device 102, device 140, and/or device 160 may be configured to perform one or more operations of a Common Mean Delay Link Service (CMLDS) technique, e.g., in accordance with an IEEE 802.1AS Standard.

For example, path delay and/or neighbor rate ratio estimation may be performed, e.g., in accordance with a IEEE 802.11 Specification, for example, using timestamps collected from an egress time and an ingress time of TM and/or FTM frames, and corresponding acknowledgements.

For example, an AP and a non-AP STA may exchange time-measurement frames, e.g., TM and/or FTM frames, for a specific time domain, for example, the time domain for which the corresponding AP operates as a GM. According to this example, the estimation of path delay and/or neighbor rate ratio may be performed with timestamps of the time-measurement frames corresponding to that time domain, e.g., in accordance with an IEEE 802.11 Specification.

For example, the resulting path delay and/or neighbor rate ratio estimates may be used in the computation of time offsets in some or all supported time domains.

For example, the AP may be connected to another device, which operates as a source of time. For example, as shown in FIG. 2, AP 202 (FIG. 2) may get a timestamp relayed via various upper machines, for example, from GPS GM 210 (FIG. 2) via gPTP bridge 203 (FIG. 2). According to this example, it may be defined that a preciseOriginTimestamp in a time domain for which time information is relayed by the AP, e.g., domain 1 (FIG. 2), may be adjusted with a residence time. For example, the residence time may include time elapsed since a corresponding follow-up message is received at an upstream PTP port, and a time when the TM or FTM frame carrying the follow-up information is transmitted. For example, as a same FTM frame may include information of multiple time domains, there may be a need to perform a delay adjustment. For example, it may be defined that domain 1 (FIG. 2) is to be adjusted to reflect delays in the time relay of domain 1 (FIG. 2).

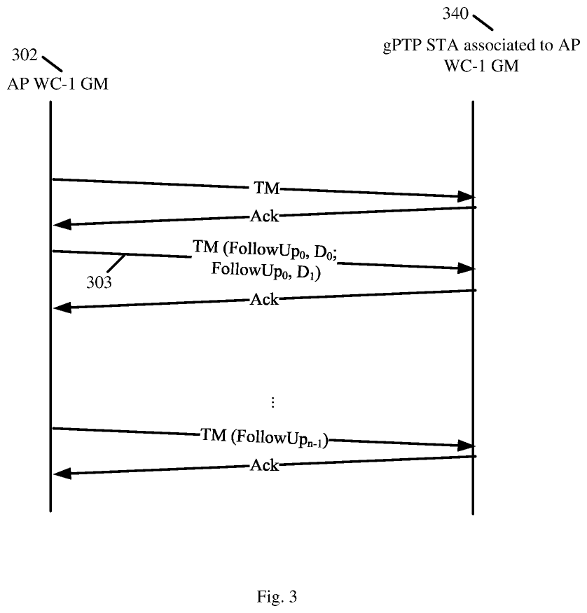

Reference is made to FIG. 3, which schematically illustrates a TM protocol 300 supporting multiple time domains, in accordance with some demonstrative aspects.

In some demonstrative aspects, an AP 302 and a gPTP STA 340 may be configured to communicate one or more TM frames according to TM protocol 300, e.g., as described below.

For example, device 102 (FIG. 1) may perform one or more operations of, one or more functionalities of, the role of, and/or the functionality of, AP 302.

For example, device 140 (FIG. 1) may perform one or more operations of, one or more functionalities of, the role of, and/or the functionality of, gPTP STA 340.

In some demonstrative aspects, as shown in FIG. 3, AP 302 may transmit a time-measurement frame 303 to gPTP STA 340.

For example, the time-measurement frame 303 may include a timing-measurement frame of a timing-measurement procedure.

For example, the time-measurement frame 303 may include a plurality of follow-up-information fields corresponding to a plurality of time domains.

For example, as shown in FIG. 3, the time-measurement frame 303 may include a first follow-up-information field including first time information corresponding to a first time domain.

For example, as shown in FIG. 3, the time-measurement frame 303 may include a second follow-up-information field including second time information corresponding to a second time domain.

For example, the time-measurement frame 303 may include timestamp information corresponding to a previous time-measurement frame communicated between the AP 302 and the gPTP STA 340.

For example, the time-measurement frame 303 may include a ToA field including a ToA timestamp in a time-base of the AP 302.

For example, the time-measurement frame 303 may include a ToD field including a ToD timestamp in the time-base of the AP 302.

For example, the gPTP STA 340 may process the time-measurement frame 303 from the AP 302, for example, to identify the timestamp information and the plurality of follow-up-information fields.

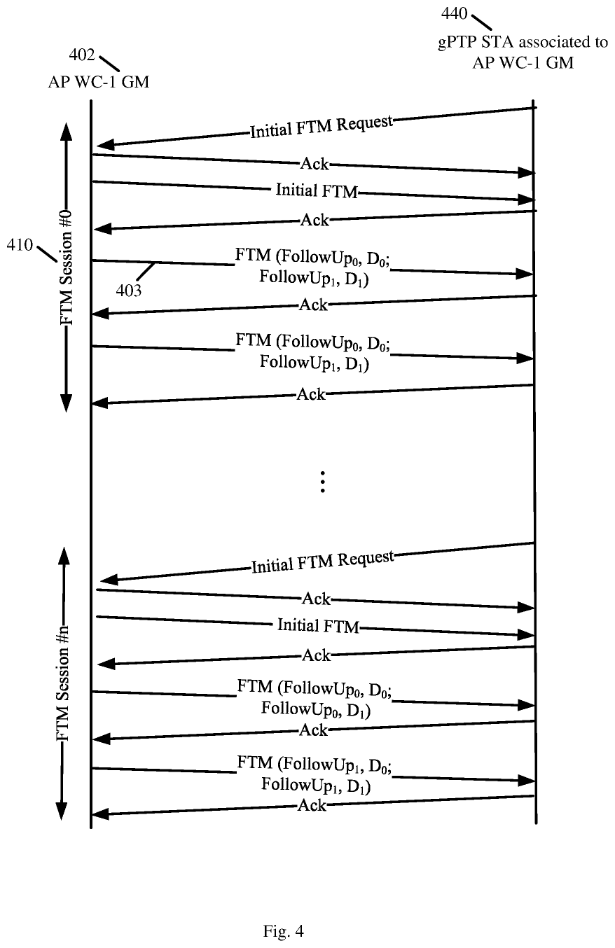

Reference is made to FIG. 4, which schematically illustrates an FTM protocol 400 supporting multiple time domains, in accordance with some demonstrative aspects.

In some demonstrative aspects, an AP 402 and a gPTP STA 440 may be configured to communicate one or more FTM frames according to the FTM protocol 400, e.g., as described below.

For example, device 102 (FIG. 1) may perform one or more operations of, one or more functionalities of, the role of, and/or the functionality of, AP 402.

For example, device 140 (FIG. 1) may perform one or more operations of, one or more functionalities of, the role of, and/or the functionality of, gPTP STA 440.

In some demonstrative aspects, as shown in FIG. 4, AP 402 may transmit a time-measurement frame 403 to gPTP STA 440, for example, during an FTM Session 410 (FTM Session #0).

For example, the time-measurement frame 403 may include an FTM frame of an FTM procedure.

For example, the time-measurement frame 403 may include a plurality of follow-up-information fields corresponding to a plurality of time domains.

For example, the time-measurement frame 403 may include timestamp information corresponding to a previous time-measurement frame communicated between the AP 402 and the gPTP STA 440.

For example, the gPTP STA 440 may process the time-measurement frame 403 from the AP 402, for example, to identify the timestamp information and the plurality of follow-up-information fields.

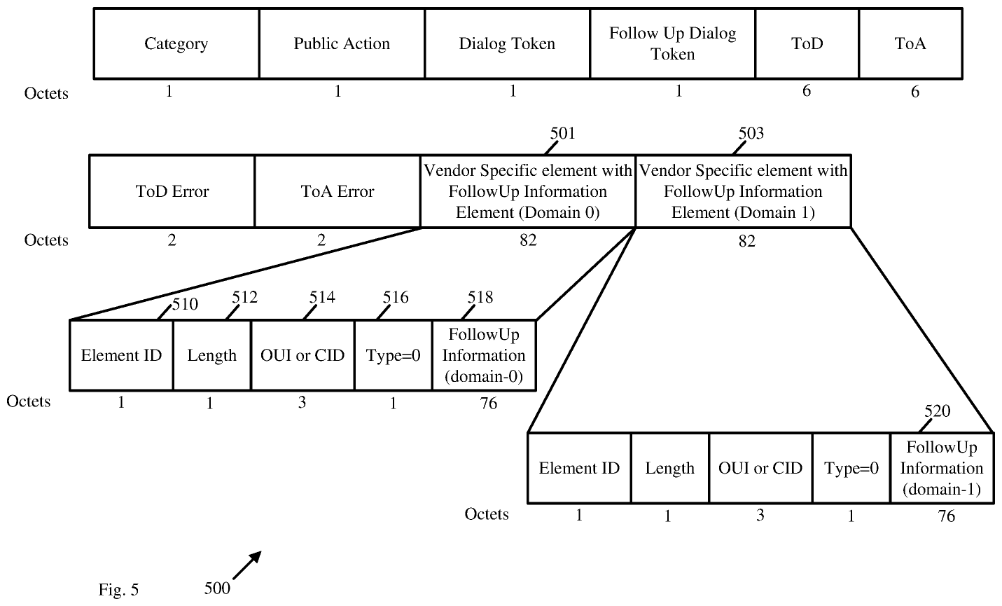

Reference is made to FIG. 5, which schematically illustrates a time-measurement frame format 500, in accordance with some demonstrative aspects.

For example, device 102 (FIG. 1), device 140 (FIG. 1), and/or device 160 (FIG. 1) may be configured to generate, process, and/or communicate one or more time-measurement frames 500, for example, according to a time measurement mechanism.

In some demonstrative aspects, the time measurement mechanism may be configured to support wireless communication of time information corresponding to a plurality of time domains, e.g., as described below.

In some demonstrative aspects, the time measurement mechanism may be configured to provide a technical solution to support wireless communication of a plurality of follow-up-information fields corresponding to the plurality of time domains, e.g., as described below.

For example, one or more fields of the time-measurement frame format 500 may be included as part of a TM frame.

For example, one or more fields of the time-measurement frame format 500 may be included as part of an FTM frame.

For example, it may be defined that for every additional supported time domain, e.g., in addition to a first time domain, an additional follow-up-information field corresponding to the additional time domain is to be added to the time-measurement frame 500, which may be sent, e.g., as a TM frame or an FTM frame, from an AP, e.g., operating as a time transmitter, to a non-AP STA, e.g., operating as a time receiver.

In some demonstrative aspects, as shown in FIG. 5, the time-measurement frame 500 may include a first vendor specific information element 501, which may include a first follow-up-information field 518 including first time information corresponding to a first time domain. For example, as shown in FIG. 5, first vendor specific information element 501 may have a length of 82 octets.

In some demonstrative aspects, as shown in FIG. 5, the time-measurement frame 500 may include a second vendor specific information element 503, which may include a second follow-up-information field 520 including second time information corresponding to a second time domain. For example, as shown in FIG. 5, second vendor specific information element 503 may have a length of 82 octets.

In some demonstrative aspects, as shown in FIG. 5, a vendor specific information element, e.g., first vendor specific information element 501 and/or second vendor specific information element 503, may include an element Identifier (ID) field 510 configured to indicate that the information element is of a type vendor specific. For example, element ID field 510 may be assigned a value of 221, for example, to indicate that the information element is of a type vendor specific, e.g., in accordance with an IEEE 802.11 Specification.

In some demonstrative aspects, as shown in FIG. 5, a vendor specific information element, e.g., first vendor specific information element 501 and/or second vendor specific information element 503, may include a length field 512 configured to indicate a number of octets in the vendor specific information element excluding element ID field 510 and length field 512. For example, length field 512 may be set to 80, for example, to indicate that the number of octets in the vendor specific information element, for example, excluding element ID field 510 and length field 512, is 80.

In some demonstrative aspects, as shown in FIG. 5, a vendor specific information element, e.g., first vendor specific information element 501 and/or second vendor specific information element 503, may include Organizationally Unique Identifier (OUI) or Company Identification (CID) field 514, e.g., in accordance with an IEEE 802.11 Specification.

In some demonstrative aspects, as shown in FIG. 5, a vendor specific information element, e.g., first vendor specific information element 501 and/or second vendor specific information element 503, may include a type field 516 set to a predefined value to indicate that the vendor specific information element includes a follow-up information field.

In some demonstrative aspects, as shown in FIG. 5, follow-up information field 518 may have a length of 76 octets.

In some demonstrative aspects, as shown in FIG. 5, follow-up information field 520 may have a length of 76 octets.

In some demonstrative aspects, follow-up information field 518 may include a header field, e.g., in accordance with an IEEE 802.1AS Standard.

In some demonstrative aspects, the header field in the follow-up information field 518 may include a PTP message header. In other aspects, the header field may include any other type of header.

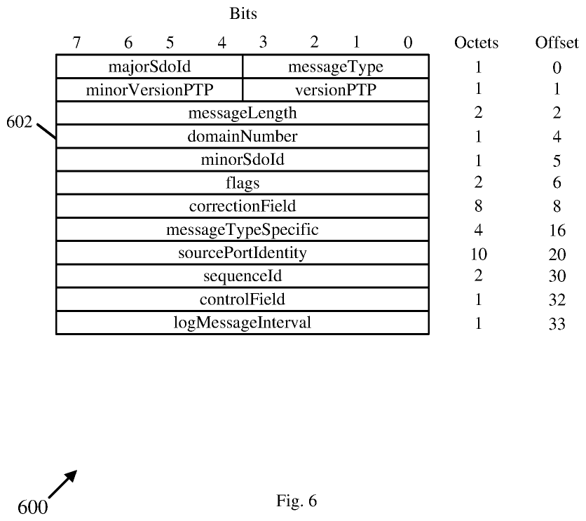

Reference is made to FIG. 6, which schematically illustrates a header field format 600, which may be implemented in accordance with some demonstrative aspects.

For example, follow-up information field 518 (FIG. 5) may include a header field 600, e.g., in accordance with an IEEE 802.1AS Standard.

For example, as shown in FIG. 6, header field 600 may include a domain number field 602, which may be configured to identify a time domain to which follow-up information field 518 (FIG. 5) corresponds.

For example, as shown in FIG. 6, header field 600 may have a length of 34 octets.

Referring back to FIG. 5, in some demonstrative aspects, time-measurement frame 500 may include a plurality of follow-up-information fields corresponding to a plurality of time domains.

In some demonstrative aspects, time-measurement frame 500 may include two follow-up-information fields, e.g., follow-up-information field 518 and follow-up-information field 520, corresponding to two respective time domains, e.g., as shown in FIG. 5.

In other aspects, time-measurement frame 500 may include more than two follow-up-information fields corresponding to more than two time domains.

In some demonstrative aspects, for example, in some implementations, scenarios, use cases, and/or deployments, when supporting a relatively large number of time domains, appending a relatively large number of follow-up-information fields to time-measurement messages, e.g., TM and/or FTM messages, may render the resulting time-measurement frame to reach the limit of the maximum frame size, e.g., as may be permitted by an IEEE 802.11 Specification.

In some demonstrative aspects, a compression function may be applied to a follow-up-information field format, for example, to reduce a size of one or more follow-up-information fields, e.g., as described below.

In some demonstrative aspects, relevant information corresponding to wireless communication of timing information may include domain number information, e.g., information in domain number field 602 (FIG. 6).

In some demonstrative aspects, the compression function may be configured to include partial information of the header field 600 (FIG. 6), e.g., as described below.

In some demonstrative aspects, a compressed header field may be configured to exclude some of the fields of header field 600 (FIG. 6), e.g., as described below.

In some demonstrative aspects, the compressed header field may be configured to include only information from domain number field 602 (FIG. 6), e.g., as described below.

In other aspects, the compressed header field may include one or more additional or alternative fields.

In some demonstrative aspects, utilizing partial information of the header field 600 (FIG. 6), e.g., using only information from domain number field 602 (FIG. 6), may provide a technical solution to reduce the size of a follow-up-information field, for example, by up to 33 octets, e.g., as described below.

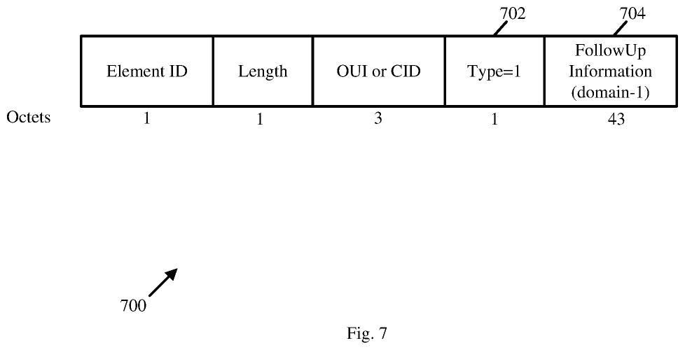

Reference is made to FIG. 7, which schematically illustrates a compressed follow-up information element format 700, in accordance with some demonstrative aspects.

For example, device 102 (FIG. 1), device 140 (FIG. 1), and/or device 160 (FIG. 1) may be configured to generate, process, and/or communicate one or more time-measurement frames including the compressed follow-up information element format 700, for example, according to a time measurement mechanism.

For example, device 102 (FIG. 1), device 140 (FIG. 1), and/or device 160 (FIG. 1) may be configured to implement one or more operations of a time measurement mechanism, which may be configured to support communication of timing information corresponding to multiple time domains.

In some demonstrative aspects, the time measurement mechanism may be configured to support communication of one or more compressed follow-up information elements 700, e.g., as vendor specific information elements, in one or more time-measurement frames, for example, to provide a technical solution to support an increased number of time domains.

In some demonstrative aspects, as shown in FIG. 7, the compressed follow-up information element 700 may have a length of 49 octets.

In some demonstrative aspects, as shown in FIG. 7, the compressed follow-up information element 700 may include a type field 702 set to a predefined type value to indicate a compressed follow-up-information field type.

For example, as shown in FIG. 7, type field 702 may be set to a value 1, or any other predefined value, to indicate that the compressed follow-up information element 700 includes a compressed follow-up-information field 704.

In some demonstrative aspects, as shown in FIG. 7, the compressed follow-up-information field 704 may have a length of 43 octets.

In some demonstrative aspects, the compressed follow-up-information field 704 may include a compressed header field, which includes, e.g., only includes, a domain number field to identify a time domain to which the compressed follow-up-information field 704 corresponds. For example, the header field of compressed follow-up-information field 704 may be configured to include, e.g., to only include, domain number field 602 (FIG. 6), for example, while excluding one or more other, e.g., all other, fields of header field 600 (FIG. 6).

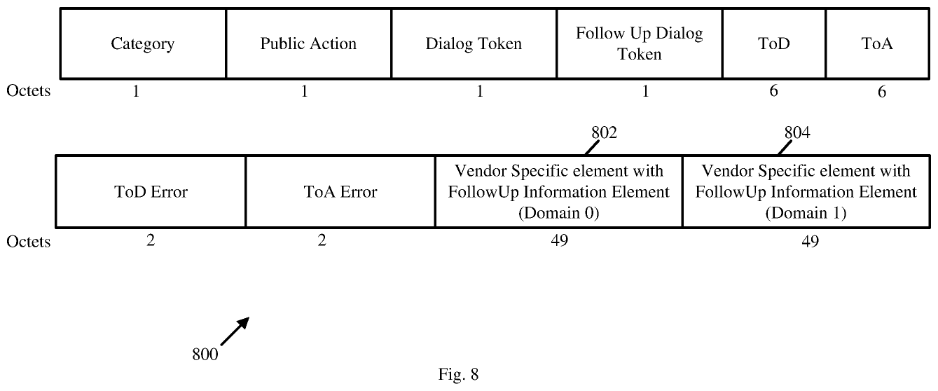

Reference is made to FIG. 8, which schematically illustrates a time-measurement frame format 800, in accordance with some demonstrative aspects.

For example, device 102 (FIG. 1), device 140 (FIG. 1), and/or device 160 (FIG. 1) may be configured to generate, process and/or communicate time-measurement frame 800, which may include one or more compressed vendor specific information elements.

In some demonstrative aspects, as shown in FIG. 8, time-measurement frame 800 may include a first compressed vendor specific information element 802 corresponding to a first time domain (Domain 0). For example, first compressed vendor specific information element 802 may have a length of 49 octets.

In some demonstrative aspects, as shown in FIG. 8, time-measurement frame 800 may include a second compressed vendor specific information element 804 corresponding to a second time domain (Domain 1). For example, second compressed vendor specific information element 804 may have a length of 49 octets.

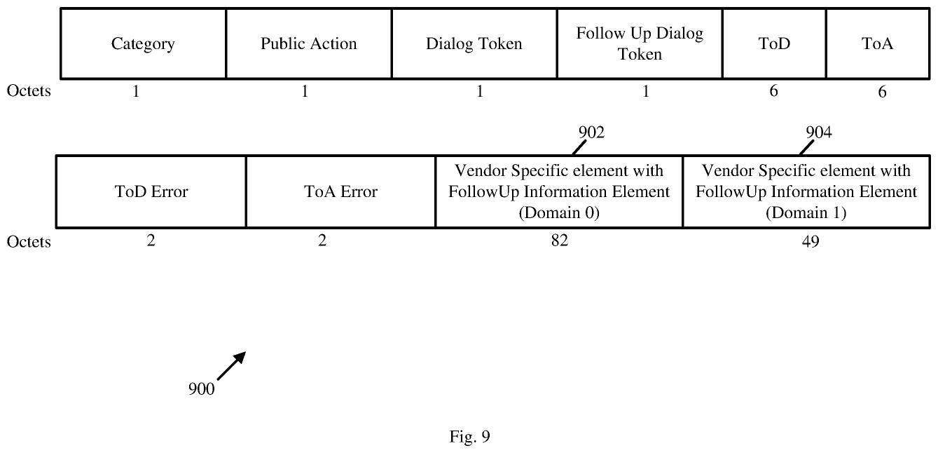

Reference is made to FIG. 9, which schematically illustrates a time-measurement frame format 900, in accordance with some demonstrative aspects.

For example, device 102 (FIG. 1), device 140 (FIG. 1), and/or device 160 (FIG. 1) may be configured to generate, process, and/or communicate time-measurement frame 900, which may include one or more vendor specific information elements.

In some demonstrative aspects, as shown in FIG. 9, time-measurement frame 900 may include at least one non-compressed vendor specific information element, and one or more compressed vendor specific information elements, for example, for compatibility reasons.

In some demonstrative aspects, as shown in FIG. 9, time-measurement frame 900 may include a first vendor specific information element 902, e.g., which may be configured as a non-compressed vendor specific information element, which may have a length of 82 octets.

For example, a type field in the first vendor specific information element 902 may be set to the value 0, for example, to indicate a non-compressed follow-up-information field type in the first vendor specific information element 902.

For example, it may be defined that a first-in-order follow-up information element in the time-measurement frame 900, e.g., the first vendor specific information element 902, is to include the non-compressed vendor specific information element, e.g., to provide a technical solution to support backward compatibility for devices supporting a single follow-up information element per time-measurement frame.

In some demonstrative aspects, as shown in FIG. 9, time-measurement frame 900 may include a second vendor specific information element 904, e.g., a compressed vendor specific information element, which may have a length of 49 octets.

For example, a type field in the second vendor specific information element 904 may be set to a value 1, for example, to indicate a compressed follow-up-information field type in the second vendor specific information element 902.

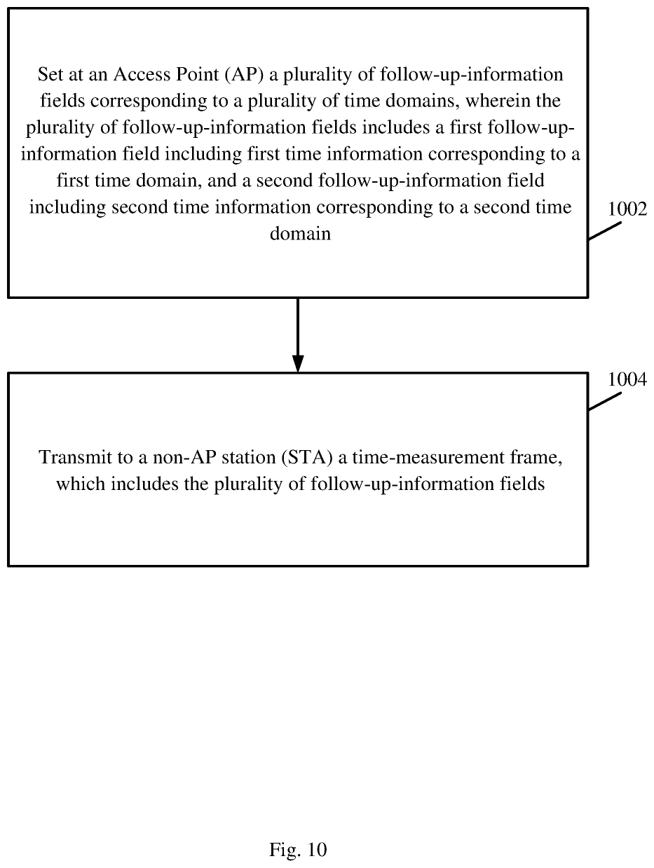

Reference is made to FIG. 10, which schematically illustrates a method of wireless communication of time information corresponding to a plurality of time domains, in accordance with some demonstrative aspects. For example, one or more of the operations of the method of FIG. 10 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 1002, the method may include setting at an AP a plurality of follow-up-information fields corresponding to a plurality of time domains. For example, the plurality of follow-up-information fields may include a first follow-up-information field including first time information corresponding to a first time domain, and a second follow-up-information field including second time information corresponding to a second time domain. For example, controller 124 (FIG. 1) may be configured to control, trigger, cause, and/or instruct an AP implemented by device 102 (FIG. 1) to set a plurality of follow-up-information fields corresponding to a plurality of time domains, for example, such that the plurality of follow-up-information fields may include a first follow-up-information field including first time information corresponding to a first time domain, and a second follow-up-information field including second time information corresponding to a second time domain, e.g., as described above.

As indicated at block 1004, the method may include transmitting a time-measurement frame from the AP to a non-AP STA. For example, the time-measurement frame may include the plurality of follow-up-information fields. For example, controller 124 (FIG. 1) may be configured to control, trigger, cause, and/or instruct the AP implemented by device 102 (FIG. 1) to transmit a time-measurement frame, which includes the plurality of follow-up-information fields, to a non-AP STA, e.g., as described above.

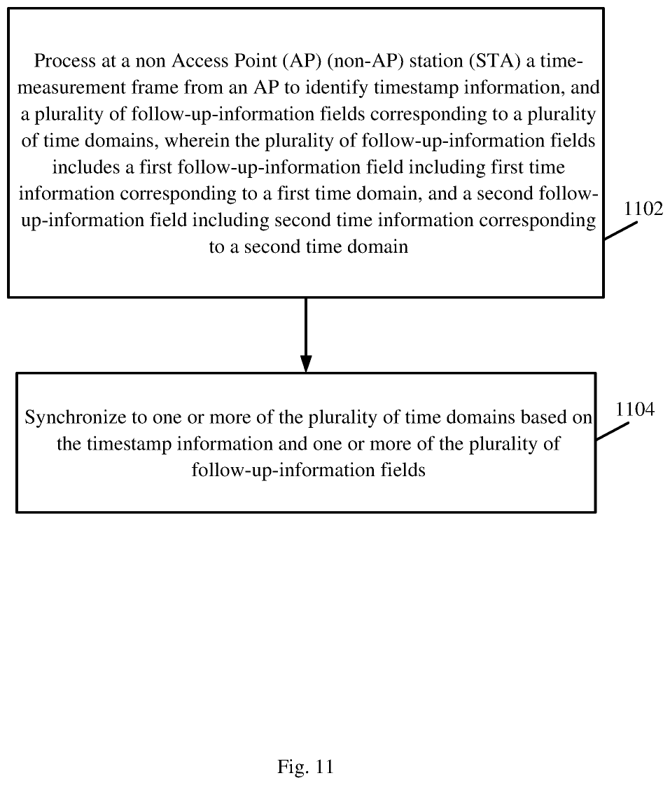

Reference is made to FIG. 11, which schematically illustrates a method of wireless communication of time information corresponding to a plurality of time domains, in accordance with some demonstrative aspects. For example, one or more of the operations of the method of FIG. 11 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 1102, the method may include processing at a non-AP STA a time-measurement frame from an AP to identify timestamp information, and a plurality of follow-up-information fields corresponding to a plurality of time domains. For example, the plurality of follow-up-information fields may include a first follow-up-information field including first time information corresponding to a first time domain, and a second follow-up-information field including second time information corresponding to a second time domain. For example, controller 154 (FIG. 1) may be configured to control, trigger, cause, and/or instruct a non-AP STA implemented by device 140 (FIG. 1) to process a time-measurement frame from an AP to identify timestamp information, and a plurality of follow-up-information fields corresponding to a plurality of time domains, for example, including a first follow-up-information field including first time information corresponding to a first time domain, and a second follow-up-information field including second time information corresponding to a second time domain, e.g., as described above.

As indicated at block 1104, the method may include synchronizing the non-AP STA to one or more of the plurality of time domains, for example, based on the timestamp information and one or more of the plurality of follow-up-information fields. For example, controller 154 (FIG. 1) may be configured to control, trigger, cause, and/or instruct the non-AP STA implemented by device 140 (FIG. 1) to synchronize to one or more of the plurality of time domains, for example, based on the timestamp information and one or more of the plurality of follow-up-information fields, e.g., as described above.

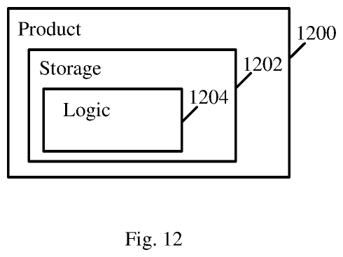

Reference is made to FIG. 12, which schematically illustrates a product of manufacture 1200, in accordance with some demonstrative aspects. Product 1200 may include one or more tangible computer-readable (“machine-readable”) non-transitory storage media 1202, which may include computer-executable instructions, e.g., implemented by logic 1204, operable to, when executed by at least one computer processor, enable the at least one computer processor to implement one or more operations at device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1); to cause device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1) to perform, trigger and/or implement one or more operations and/or functionalities; and/or to perform, trigger and/or implement one or more operations and/or functionalities described with reference to the FIGS. 1-11, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 1200 and/or machine readable storage media 1202 may include one or more types of computer-readable storage media capable of storing data, including volatile memory, non-volatile memory, removable or non-removable memory, erasable or non-erasable memory, writeable or re-writeable memory, and the like. For example, machine readable storage media 1202 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 1204 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 1204 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### Examples

The following examples pertain to further aspects.

Example 1 includes an apparatus comprising logic and circuitry configured to cause an Access Point (AP) to set a plurality of follow-up-information fields corresponding to a plurality of time domains, wherein the plurality of follow-up-information fields comprises a first follow-up-information field comprising first time information corresponding to a first time domain, and a second follow-up-information field comprising second time information corresponding to a second time domain; and transmit a time-measurement frame to a non-AP station (STA), the time-measurement frame comprising the plurality of follow-up-information fields.

Example 2 includes the subject matter of Example 1, and optionally, wherein the apparatus is configured to cause the AP to set the first follow-up-information field in a first vendor specific information element, and to set the second follow-up-information field in a second vendor specific information element, wherein the time-measurement frame comprises the first vendor specific information element and the second vendor specific information element.

Example 3 includes the subject matter of Example 2, and optionally, wherein the first vendor specific information element has a length of 82 octets, and the second vendor specific information element has a length of 82 octets.

Example 4 includes the subject matter of Example 3, and optionally, wherein each of the first follow-up-information field and the second follow-up-information field has a length of 76 octets.

Example 5 includes the subject matter of Example 2, and optionally, wherein at least one of the first vendor specific information element or the second vendor specific information element is configured as a compressed vendor specific information element having a length of less than 82 octets.

Example 6 includes the subject matter of Example 5, and optionally, wherein at least one of the first follow-up-information field or the second follow-up-information field is configured as a compressed follow-up-information field having a length of less than 76 octets.

Example 7 includes the subject matter of Example 6, and optionally, wherein the compressed follow-up-information field comprises a compressed header field having a length of less than 34 octets.

Example 8 includes the subject matter of Example 7, and optionally, wherein the compressed header field comprises a domain number field to identify a time domain to which the compressed follow-up-information field corresponds.

Example 9 includes the subject matter of Example 7 or 8, and optionally, wherein the compressed header field has a length of 1 octet.

Example 10 includes the subject matter of any one of Examples 6-9, and optionally, wherein the compressed follow-up-information field has a length of 43 octets.

Example 11 includes the subject matter of any one of any one of Examples 5-10, and optionally, wherein the compressed vendor specific information element comprises a type field set to a predefined type value to indicate a compressed follow-up-information field type.

Example 12 includes the subject matter of any one of Examples 5-11, and optionally, wherein the compressed vendor specific information element has a length of 49 octets.

Example 13 includes the subject matter of any one of Examples 5-12, and optionally, wherein the first vendor specific information element has a length of 82 octets, and the second vendor specific information element is configured as the compressed vendor specific information element.

Example 14 includes the subject matter of any one of Examples 5-12, and optionally, wherein each of the first vendor specific information element and the second vendor specific information element is configured as the compressed vendor specific information element.

Example 15 includes the subject matter of Example 1, and optionally, wherein the apparatus is configured to cause the AP to set the first follow-up-information field and the second follow-up-information field in a vendor specific information element, wherein the vendor specific information element comprises a type field set to a predefined value to indicate that the vendor specific information element comprises follow-up information, and a count field to indicate a count of follow-up-information fields included in the vendor specific information element.

Example 16 includes the subject matter of Example 15, and optionally, wherein the first follow-up-information field has a length of 76 octets, and the second follow-up-information field has a length of 76 octets.

Example 17 includes the subject matter of Example 15, and optionally, wherein at least one of the first follow-up-information field or the second follow-up-information field is configured as a compressed follow-up-information field having a length of less than 76 octets.

Example 18 includes the subject matter of any one of Examples 1-17, and optionally, wherein the apparatus is configured to cause the AP to set a first domain number field in a header field of the first follow-up-information field to identify the first time domain, and to set a second domain number field in a header field of the second follow-up-information field to identify the second time domain.

Example 19 includes the subject matter of any one of Examples 1-18, and optionally, wherein the apparatus is configured to cause the AP to set the first time information in the first follow-up-information field by setting a first precise-origin-timestamp field and a first follow-up information Type, Length, Value (TLV) field in the first follow-up-information field, and to set the second time information in the second follow-up-information field by setting a second precise-origin-timestamp field and a second follow-up information TLV field in the second follow-up-information field.

Example 20 includes the subject matter of any one of Examples 1-19, and optionally, wherein the time-measurement frame comprises timestamp information corresponding to a previous time-measurement frame communicated between the AP and the non-AP STA.

Example 21 includes the subject matter of any one of Examples 1-20, and optionally, wherein the time-measurement frame comprises a Time of Arrival (ToA) field comprising a ToA timestamp in a time-base of the AP, and a Time of Departure (ToD) field comprising a ToD timestamp in the time-base of the AP.

Example 22 includes the subject matter of any one of Examples 1-21, and optionally, wherein the time-measurement frame comprises a timing-measurement frame of a timing-measurement procedure.

Example 23 includes the subject matter of any one of Examples 1-21, and optionally, wherein the time-measurement frame comprises a Fine Timing Measurement (FTM) frame of an FTM procedure.

Example 24 includes the subject matter of any one of Examples 1-24, and optionally, wherein the plurality of follow-up-information fields comprises at least a third follow-up-information field corresponding to at least a third time domain.

Example 25 includes the subject matter of any one of Examples 1-24, and optionally, comprising at least one radio to transmit the time-measurement frame from the AP.

Example 26 includes the subject matter of Example 25, and optionally, comprising one or more antennas connected to the radio, and a processor to execute instructions of an operating system.

Example 27 includes an apparatus comprising logic and circuitry configured to cause a non Access Point (AP) (non-AP) station (STA) to process a time-measurement frame from an AP to identify timestamp information, and a plurality of follow-up-information fields corresponding to a plurality of time domains, wherein the plurality of follow-up-information fields comprises a first follow-up-information field comprising first time information corresponding to a first time domain, and a second follow-up-information field comprising second time information corresponding to a second time domain; and synchronize to one or more of the plurality of time domains based on the timestamp information and one or more of the plurality of follow-up-information fields.

Example 28 includes the subject matter of Example 27, and optionally, wherein the apparatus is configured to cause the non-AP STA to identify the first follow-up-information field in a first vendor specific information element, and to identify the second follow-up-information field in a second vendor specific information element, wherein the time-measurement frame comprises the first vendor specific information element and the second vendor specific information element.

Example 29 includes the subject matter of Example 28, and optionally, wherein the first vendor specific information element has a length of 82 octets, and the second vendor specific information element has a length of 82 octets.

Example 30 includes the subject matter of Example 29, and optionally, wherein each of the first follow-up-information field and the second follow-up-information field has a length of 76 octets.

Example 31 includes the subject matter of Example 28, and optionally, wherein at least one of the first vendor specific information element or the second vendor specific information element is configured as a compressed vendor specific information element having a length of less than 82 octets.

Example 32 includes the subject matter of Example 31, and optionally, wherein at least one of the first follow-up-information field or the second follow-up-information field is configured as a compressed follow-up-information field having a length of less than 76 octets.

Example 33 includes the subject matter of Example 32, and optionally, wherein the compressed follow-up-information field comprises a compressed header field having a length of less than 34 octets.

Example 34 includes the subject matter of Example 33, and optionally, wherein the compressed header field comprises a domain number field to identify a time domain to which the compressed follow-up-information field corresponds.

Example 35 includes the subject matter of Example 33 or 34, and optionally, wherein the compressed header field has a length of 1 octet.

Example 36 includes the subject matter of any one of Examples 32-35, and optionally, wherein the compressed follow-up-information field has a length of 43 octets.

Example 37 includes the subject matter of any one of any one of Examples 31-36, and optionally, wherein the compressed vendor specific information element comprises a type field set to a predefined type value to indicate a compressed follow-up-information field type.

Example 38 includes the subject matter of any one of Examples 31-37, and optionally, wherein the compressed vendor specific information element has a length of 49 octets.

Example 39 includes the subject matter of any one of Examples 31-38, and optionally, wherein the first vendor specific information element has a length of 82 octets, and the second vendor specific information element is configured as the compressed vendor specific information element.

Example 40 includes the subject matter of any one of Examples 31-38, and optionally, wherein each of the first vendor specific information element and the second vendor specific information element is configured as the compressed vendor specific information element.

Example 41 includes the subject matter of Example 27, and optionally, wherein the apparatus is configured to cause the non-AP STA to identify the first follow-up-information field and the second follow-up-information field in a vendor specific information element, wherein the vendor specific information element comprises a type field set to a predefined value to indicate that the vendor specific information element comprises follow-up information, and a count field to indicate a count of follow-up-information fields included in the vendor specific information element.

Example 42 includes the subject matter of Example 41, and optionally, wherein the first follow-up-information field has a length of 76 octets, and the second follow-up-information field has a length of 76 octets.

Example 43 includes the subject matter of Example 41, and optionally, wherein at least one of the first follow-up-information field or the second follow-up-information field is configured as a compressed follow-up-information field having a length of less than 76 octets.

Example 44 includes the subject matter of any one of Examples 27-43, and optionally, wherein the apparatus is configured to cause the non-AP STA to identify the first time domain based on a first domain number field in a header field of the first follow-up-information field, and to identify the second time domain based on a second domain number field in a header field of the second follow-up-information field.

Example 45 includes the subject matter of any one of Examples 27-44, and optionally, wherein the apparatus is configured to cause the non-AP STA to identify the first time information in the first follow-up-information field by processing a first precise-origin-timestamp field and a first follow-up information Type, Length, Value (TLV) field in the first follow-up-information field, and to identify the second time information in the second follow-up-information field by processing a second precise-origin-timestamp field and a second follow-up information TLV field in the second follow-up-information field.

Example 46 includes the subject matter of any one of Examples 27-45, and optionally, wherein the timestamp information corresponds to a previous time-measurement frame communicated between the AP and the non-AP STA.

Example 47 includes the subject matter of any one of Examples 27-46, and optionally, wherein the time-measurement frame comprises a Time of Arrival (ToA) field comprising a ToA timestamp in a time-base of the AP, and a Time of Departure (ToD) field comprising a ToD timestamp in the time-base of the AP.

Example 48 includes the subject matter of any one of Examples 27-47, and optionally, wherein the time-measurement frame comprises a timing-measurement frame of a timing-measurement procedure.

Example 49 includes the subject matter of any one of Examples 27-47, and optionally, wherein the time-measurement frame comprises a Fine Timing Measurement (FTM) frame of an FTM procedure.

Example 50 includes the subject matter of any one of Examples 27-49, and optionally, comprising at least one radio to receive the time-measurement frame from the AP.

Example 51 includes the subject matter of Example 50, and optionally, comprising one or more antennas connected to the radio, and a processor to execute instructions of an operating system.

Example 52 comprises a wireless communication device comprising the apparatus of any of Examples 1-51.

Example 53 comprises a mobile device comprising the apparatus of any of Examples 1-51.

Example 54 comprises an apparatus comprising means for executing any of the described operations of any of Examples 1-51.

Example 55 comprises a product comprising one or more tangible computer-readable non-transitory storage media comprising instructions operable to, when executed by at least one processor, enable the at least one processor to cause a wireless communication device to perform any of the described operations of any of Examples 1-51.

Example 56 comprises an apparatus comprising: a memory interface; and processing circuitry configured to: perform any of the described operations of any of Examples 1-51.

Example 57 comprises a method comprising any of the described operations of any of Examples 1-51.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising logic and circuitry configured to cause an Access Point (AP) to:
set a plurality of follow-up-information fields corresponding to a plurality of time domains, wherein the plurality of follow-up-information fields comprises a first follow-up-information field comprising first time information corresponding to a first time domain, and a second follow-up-information field comprising second time information corresponding to a second time domain; and
transmit a time-measurement frame to a non-AP station (STA), the time-measurement frame comprising the plurality of follow-up-information fields.

2. The apparatus of claim 1 configured to cause the AP to set the first follow-up-information field in a first vendor specific information element, and to set the second follow-up-information field in a second vendor specific information element, wherein the time-measurement frame comprises the first vendor specific information element and the second vendor specific information element.

3. The apparatus of claim 2, wherein the first vendor specific information element has a length of 82 octets, and the second vendor specific information element has a length of 82 octets.

4. The apparatus of claim 2, wherein at least one of the first vendor specific information element or the second vendor specific information element is configured as a compressed vendor specific information element having a length of less than 82 octets.

5. The apparatus of claim 4, wherein at least one of the first follow-up-information field or the second follow-up-information field is configured as a compressed follow-up-information field having a length of less than 76 octets.

6. The apparatus of claim 5, wherein the compressed follow-up-information field comprises a compressed header field having a length of less than 34 octets.

7. The apparatus of claim 6, wherein the compressed header field comprises a domain number field to identify a time domain to which the compressed follow-up-information field corresponds.

8. The apparatus of claim 6, wherein the compressed header field has a length of 1 octet.

9. The apparatus of claim 4, wherein the compressed vendor specific information element comprises a type field set to a predefined type value to indicate a compressed follow-up-information field type.

10. The apparatus of claim 4, wherein the compressed vendor specific information element has a length of 49 octets.

11. The apparatus of claim 1 configured to cause the AP to set the first follow-up-information field and the second follow-up-information field in a vendor specific information element, wherein the vendor specific information element comprises a type field set to a predefined value to indicate that the vendor specific information element comprises follow-up information, and a count field to indicate a count of follow-up-information fields included in the vendor specific information element.

12. The apparatus of claim 1 configured to cause the AP to set a first domain number field in a header field of the first follow-up-information field to identify the first time domain, and to set a second domain number field in a header field of the second follow-up-information field to identify the second time domain.

13. The apparatus of claim 1 configured to cause the AP to set the first time information in the first follow-up-information field by setting a first precise-origin-timestamp field and a first follow-up information Type, Length, Value (TLV) field in the first follow-up-information field, and to set the second time information in the second follow-up-information field by setting a second precise-origin-timestamp field and a second follow-up information TLV field in the second follow-up-information field.

14. The apparatus of claim 1, wherein the time-measurement frame comprises timestamp information corresponding to a previous time-measurement frame communicated between the AP and the non-AP STA.

15. The apparatus of claim 1, wherein the time-measurement frame comprises a Time of Arrival (ToA) field comprising a ToA timestamp in a time-base of the AP, and a Time of Departure (ToD) field comprising a ToD timestamp in the time-base of the AP.

16. The apparatus of claim 1, wherein the plurality of follow-up-information fields comprises at least a third follow-up-information field corresponding to at least a third time domain.

17. The apparatus of claim 1 comprising at least one radio to transmit the time-measurement frame from the AP.

18. The apparatus of claim 17 comprising one or more antennas connected to the radio, and a processor to execute instructions of an operating system.

19. A product comprising one or more tangible computer-readable non-transitory storage media comprising instructions operable to, when executed by at least one processor, enable the at least one processor to cause an Access Point (AP) to:
set a plurality of follow-up-information fields corresponding to a plurality of time domains, wherein the plurality of follow-up-information fields comprises a first follow-up-information field comprising first time information corresponding to a first time domain, and a second follow-up-information field comprising second time information corresponding to a second time domain; and
transmit a time-measurement frame to a non-AP station (STA), the time-measurement frame comprising the plurality of follow-up-information fields.

20. The product of claim 19, wherein the instructions, when executed, cause the AP to set the first follow-up-information field in a first vendor specific information element, and to set the second follow-up-information field in a second vendor specific information element, wherein the time-measurement frame comprises the first vendor specific information element and the second vendor specific information element.
